(19) United States
(12) Patent Application Publication
(10) Pub. No.: US 2026/0035573 A1
(43) Pub. Date: Feb. 5, 2026

(54) SEALANTS FOR INHIBITING CORROSION

(71) Applicant: THE BOEING COMPANY, Arlington, VA (US)

(72) Inventors: Carissa A. PAJEL, Mercer Island, WA (US); Waynie M. SCHUETTE, Troy, IL (US); Kay BLOHOWIAK, Issaquah, WA (US)

(21) Appl. No.: 18/669,273

(22) Filed: May 20, 2024

Related U.S. Application Data
(60) Provisional application No. 63/603,359, filed on Nov. 28, 2023.
(60) Provisional application No. 63/560,256, filed on Mar. 1, 2024.

(51) Int. Cl. C09D 5/08; C08K 5/00; C09D 7/63; C09D 181/04; C23F 11/16

(52) U.S. Cl. CPC C09D 5/086; C09D 7/63; C09D 181/04; C23F 11/16; C08K 5/0091

(57) ABSTRACT

The present disclosure provides methods of protecting a substrate from corrosion. The methods include applying a coating composition to a surface of the substrate. The coating composition includes a corrosion inhibitor including a metal organic framework (MOF). The metal organic framework includes a metal ion coordinated to one or more organic ligands. The one or more organic ligands include at least one exocyclic sulphur group. The metal ion of the MOFs includes a rare earth metal or transition metal. The coating composition includes a sealant including a non-stoichiometric sensitive composition and an activator.

### CROSS-REFERENCE TO RELATED APPLICATIONS

This application claims priority to U.S. Provisional Patent Application No. 63/560,256, filed Mar. 1, 2024 and U.S. Provisional Patent Application No. 63/603,359 filed Nov. 28, 2023, each of which are incorporated herein by reference in their entirety.

### GOVERNMENT RIGHTS

This invention was made with government support under Grant Number W912HQ-22-C-0099 awarded by the Department of Defense. The government has certain rights in the invention.

### FIELD

Aspects of the present disclosure relate to processes, compositions and agents for inhibiting corrosion in various substrates, for example metal substrates. The present disclosure also relates to coating compositions having one or more corrosion inhibitors including one or more organometallic compounds such as metal-organic frameworks (MOFs).

### BACKGROUND

Protection of substrates, such as metal substrates, against atmospheric corrosion presents a difficult challenge and has significant economic importance. A range of metal substrates amenable to protecting from corrosion typically include aluminum alloys used in the aerospace industry, ferrous metals, zinc metals, and alloys used for protective coatings.

Pigment grade corrosion inhibitors used in organic primers are well known to be amenable to anionic species with inhibitor activity that have limited, but effective, solubility in water. For these reasons, chromate based corrosion inhibitor species have been preferred in both corrosion control technologies applied on aluminum for protection against atmospheric corrosion, for example provided in sealants. The hexavalent chromate ion has proven to be an excellent corrosion inhibitor for many metals and alloy systems for many decades. However, there has been extensive research for almost 30 years for finding environmentally acceptable replacements.

Unfortunately, the number of inorganic corrosion inhibitors available for chromate replacement is limited essentially to a few anionic species, such as zinc borate, 2-benzothiazolylthiobutanedioic acid, zinc orthophosphate, sodium titanate, and tricalcium phosphate. Moreover, organic corrosion inhibitors, such as carbocyclic and heterocyclic aromatic structures, suffer from various limitations including limited corrosion inhibiting activity or incompatibility with various coating compositions. Indeed, these inorganic corrosion inhibitor species and organic corrosion inhibitors are generally implemented in coating compositions such as polythioethers or polyurethanes, which involve strict stoichiometric ratios of reactants in the sealant, preventing additional additives or additional corrosion inhibitors from being incorporated into the coating composition.

There is a need for improved coating compositions capable of protecting substrates, such as metal substrates that are chromate-free corrosion inhibitors.

### SUMMARY

The present disclosure provides methods of protecting a substrate from corrosion. In some aspects, a method includes applying a coating composition to a surface of the substrate. The coating composition includes a corrosion inhibitor including a metal organic framework (MOF). The metal organic framework includes a metal ion coordinated to one or more organic ligands. The one or more organic ligands include at least one exocyclic sulphur group. The metal ion of the MOFs includes a rare earth metal or transition metal. The coating composition includes a sealant including a non-stoichiometric sensitive composition and an activator.

The present disclosure also provides methods of protecting a substrate from corrosion. In some aspects, a method includes applying a coating composition to a surface of the substrate. The coating composition includes a corrosion inhibitor including a metal organic framework (MOF). The metal organic framework includes a metal ion coordinated to one or more organic ligands. The one or more organic ligands include at least one exocyclic sulphur group represented by Formula 1:

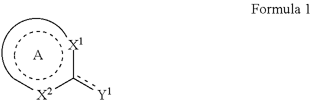

in which, A is a 5- or 6-membered aryl, heteroaryl or heterocyclic ring, which is optionally substituted with one or more substituents and optionally fused with one or more aryl or heteroaryl rings, wherein a dotted line represents one or more optional double bonds; Y¹ is selected from S or SH, wherein a dotted line represents a double bond when Y¹ is S or is absent when Y¹ is SH; X¹ is selected from N, NH, O, and S; X² is selected from N, NR⁵, O, S, CR⁶ and CR⁷R⁸; R⁵ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and R⁶, R⁷ and R⁸, are each independently selected from hydrogen, halo, thiol, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted. The metal ion of the MOFs includes a rare earth metal or transition metal. The coating composition includes a sealant including a non-stoichiometric composition and an activator.

### BRIEF DESCRIPTION OF THE DRAWINGS

So that the manner in which the above recited features can be understood in detail, a more particular description, briefly summarized above, can be had by reference to example aspects, some of which are illustrated in the appended drawings.

FIG. 1 is a photo illustrating a coating composition disposed on a bare aluminum panel, according to aspects of the present disclosure.

FIGS. 2A-2I are photos illustrating corrosion test results of bare aluminum, cadmium plated stainless steel, and/or bare titanium, according to aspects of the present disclosure. FIG. 2A depicts bare aluminum coated with a sealant having no corrosion inhibitor that was tested using a bare aluminum cathode. FIG. 2B depicts bare aluminum coated with a sealant having a chromated corrosion inhibitor that was tested using a bare aluminum cathode. FIG. 2C depicts bare aluminum coated with a sealant having a MOF corrosion inhibitor that was tested using a bare aluminum cathode. FIG. 2D depicts bare aluminum coated with a sealant having no corrosion inhibitor that was tested using a cadmium-plated stainless steel cathode. FIG. 2E depicts bare aluminum coated with a sealant having a chromated corrosion inhibitor that was tested using a cadmium-plated stainless steel cathode. FIG. 2F depicts bare aluminum coated with a sealant having a MOF corrosion inhibitor that was tested using a cadmium-plated stainless steel cathode. FIG. 2G depicts bare aluminum coated with a sealant having no corrosion inhibitor that was tested using a titanium cathode. FIG. 2H depicts bare aluminum coated with a sealant having a chromated corrosion inhibitor that was tested using a titanium cathode. FIG. 2I depicts bare aluminum coated with a sealant having a MOF corrosion inhibitor that was tested using a titanium cathode.

FIG. 3 is a diagram illustrating a test configuration of a cathode overlaying a sealant that is coated on a bare aluminum panel, according to aspects of the present disclosure.

### DETAILED DESCRIPTION

The present disclosure provides coating compositions having one or more corrosion inhibitors including one or more organometallic compounds such as metal-organic frameworks (MOFs). The coating compositions can include polysulfide compositions that provide a stable platform for the one or more organometallic compounds, e.g., metal-organic frameworks (MOFs), in a non-stoichiometrically sensitive system, where a non-stoichiometrically sensitive system is a system that remains aqueous under varying reactant ratios, e.g., reactant ratios of Formula I to the metal ion and/or reactant ratios of the MOF to the activator. An example, of a non-stoichiometrically sensitive system can include a polysulfide composition. The polysulfide composition can reduce production costs of producing a coating composition as compared to conventional sealant compositions that can incorporate strict stoichiometric ratios of reactants in the sealant, e.g., polythioethers or polyurethanes. The coating compositions reduce and/or eliminate the use of chromates, increasing safety by reducing or limiting exposure of personnel to chromates. Additionally, the coating compositions can include one or more MOFs that include both metal and organic ligand corrosion inhibitors, where the combination of the metal and organic ligand corrosion inhibitors can synergistically reduce and/or prevent corrosion of the metal substrate. As used herein, the term “substrate” refers to any structure that can be amenable to protection from corrosion and that can be cleaned and/or protected and/or modified to provide unique properties. The substrate can comprise at least a portion of its surface being metallic or being of any other material susceptible to corrosion. The substrate can be a metal substrate.

As used herein, the term “metal substrate” refers to a structure having at least a metallic portion on a surface of the structure. The metallic portion can be cleaned and/or protected and/or modified to provide unique properties. For example, a metal substrate can include copper-containing alloys, copper-containing aluminium alloys, aluminium alloys, metal alloys, or a combination thereof.

As used herein, the term “extender” and/or “extender pigment”, refers to a pigment that can be incorporated into a paint formulation to provide volume to the final resulting coating after paint curing. Extenders that add volume can be referred to as “fillers” and/or “extenders/fillers.” In at least one aspect, an extender can be an active component in corrosion resistance.

As used herein, the term “coating” refers to a material (organic or inorganic) that can be applied either as a liquid (e.g., paint) or solid (e.g., powder) to a substrate to form a film. Such materials include powder coatings, paints, sealants, conducting polymers, sol gels (e.g. Boegel made by Boeing Co., at Arlington, Virginia), silicates, silicones, zirconates, titanates, and the like. A “coating” can be comprised of a mixture of binders, solvents, pigments and additives. In at least one aspect a coating can have one or more substances from each of the four categories. Coating properties, such as gloss and color, can be related to the film surface, for example as a two-dimensional entity. However, the bulk properties of a coating can be related to its three-dimensional structure. Phase continuity can be a volume concept, and the coating performance can be dependent on the integrity of the binder phase.

As used herein, the term “film-forming organic material” or “film-forming material” refers to any material that can be used to make coatings, including monomers, co-monomers, or resins. The material can also be referred to as a “binder”, and can be either organic or inorganic. In at least one aspect, the organic material can have a carbon backbone and the inorganic material can have a silicone backbone. Organic binders can be made up of organic monomers and oligomers from which the binders generally derive their names. For example, organic binders can include acrylic, epoxy, urethane, and/or melamine. Binders can also include epoxy-based resin binders including water reducible epoxy-polyamide systems or non-epoxy-based resin binders, e.g., urethanes, ureas, acrylates, alkyls, melamines, polyesters, vinyls, vinyl esters, silicones, siloxanes, silicates, sulfides, silicate polymers, epoxy novolacs, epoxy phenolics, drying oils, hydrocarbon polymers, and the like.

As used herein, the term “weight percent (wt %)”, refers to the weight percent of a particular solid component, e.g., pigment, extender, binder, or a combination thereof, as compared with all solid components present in the coating.

As will be understood, an aromatic group means a cyclic group having 4m+2 π electrons, where m is an integer equal to or greater than 1. As used herein, “aromatic” is used interchangeably with “aryl” to refer to an aromatic group, regardless of the valency of aromatic group. Aryl can include monovalent aromatic groups, bivalent aromatic groups, or higher multivalency aromatic groups.

The term “joined” refers to a ring, moiety or group that is bonded to at least one other ring, moiety or group by a single covalent bond.

The term “fused” refers to one or more rings that share at least two common ring atoms with one or more other rings.

A heteroaromatic group is an aromatic group or ring containing one or more heteroatoms, such as N, O, S, Se, Si, or P. As used herein, “heteroaromatic” is used interchangeably with “heteroaryl”, and a heteroaryl group refers to monovalent aromatic groups, bivalent aromatic groups and higher multivalency aromatic groups containing one or more heteroatoms.

The term “optionally substituted” refers to a group that is either substituted or unsubstituted, at any available position. Substitution can be with one or more groups selected from, e.g., alkyl, alkenyl, alkynyl, cycloalkyl, cycloalkenyl, aryl, heterocyclyl, heteroaryl, formyl, alkanoyl, cycloalkanoyl, aroyl, heteroaroyl, carboxyl, alkoxycarbonyl, cycloalkyloxycarbonyl, aryloxycarbonyl, heterocyclyloxycarbonyl, heteroaryloxycarbonyl, alkylaminocarbonyl, cycloalkylaminocarbonyl, arylaminocarbonyl, heterocyclylaminocarbonyl, heteroarylaminocarbonyl, cyano, alkoxy, cycloalkoxy, aryloxy, heterocyclyloxy, heteroaryloxy, alkanoate, cycloalkanoate, aryloate, heterocyclyloate, heteroaryloate, alkylcarbonylamino, cycloalkylcarbonylamino, arylcarbonylamino, heterocyclylcarbonylamino, heteroarylcarbonylamino, nitro, hydroxyl, halo, haloalkyl, haloaryl, haloheterocyclyl, haloheteroaryl, haloalkoxy, silylalkyl, alkenylsilylalkyl, alkynylsilylalkyl, and amino. The optional substitution can be one or more groups selected from halo, alkyl, formyl, and amino. The optional substituents can include salts of the groups, for example carboxylate salts. It will be appreciated that other groups not specifically described can also be used.
“Alkyl” whether used alone, or in compound words such as alkoxy, alkylthio, alkylamino, dialkylamino or haloalkyl, refers to straight or branched chain hydrocarbons ranging in size from one to about 10 carbon atoms, or more. Alkyl moieties can include moieties ranging in size, for example, from one to about 6 carbon atoms or greater, such as, methyl, ethyl, n-propyl, iso-propyl and/or butyl, pentyl, hexyl, and higher isomers, including, e.g., those straight or branched chain hydrocarbons ranging in size from about 6 to about 10 carbon atoms, or greater.
“Alkenyl” whether used alone, or in compound words such as alkenyloxy or haloalkenyl, refers to straight or branched chain hydrocarbons containing at least one carbon-carbon double bond, including moieties ranging in size from two to about 6 carbon atoms or greater, such as, methylene, ethylene, 1-propenyl, 2-propenyl, and/or butenyl, pentenyl, hexenyl, and higher isomers, including, e.g., those straight or branched chain hydrocarbons ranging in size, for example, from about 6 to about 10 carbon atoms, or greater.
“Alkynyl” whether used alone, or in compound words such as alkynyloxy, refers to straight or branched chain hydrocarbons containing at least one carbon-carbon triple bond, including moieties ranging in size from, e.g., two to about 6 carbon atoms or greater, such as, ethynyl, 1-propynyl, 2-propynyl, and/or butynyl, pentynyl, hexynyl, and higher isomers, including, e.g., those straight or branched chain hydrocarbons ranging in size from, e.g., about 6 to about 10 carbon atoms, or greater.
“Cycloalkyl” refers to a mono- or polycarbocyclic ring system of varying sizes, e.g., from about 3 to about 10 carbon atoms, e.g., cyclopropyl, cyclobutyl, cyclopentyl, cyclohexyl or cycloheptyl. The term cycloalkyloxy can include groups linked through an oxygen atom such as cyclopentyloxy and cyclohexyloxy. The term cycloalkylthio can include groups linked through a sulfur atom such as cyclopentylthio and cyclohexylthio.
“Cycloalkenyl” refers to a non-aromatic mono- or polycarbocyclic ring system, e.g., of about 3 to about 10 carbon atoms containing at least one carbon-carbon double bond, e.g., cyclopentenyl, cyclohexenyl or cycloheptenyl. The term “cycloalkenyloxy” can include groups linked through an oxygen atom such as cyclopentenyloxy and cyclohexenyloxy. The term “cycloalkenylthio” can include groups linked through a sulfur atom such as cyclopentenylthio and cyclohexenylthio.

The terms, “carbocyclic” and “carbocyclyl” refer to a ring system having all carbon atoms, e.g., about 3 to about 10 carbon atoms, which can be aromatic, non-aromatic, saturated, or unsaturated, and can be substituted and/or carry fused rings. Examples of such groups include benzene, cyclopentyl, cyclohexyl, or fully or partially hydrogenated phenyl, naphthyl and fluorenyl.
“Aryl” whether used alone, or in compound words such as arylalkyl, aryloxy or arylthio, refers to: (i) an optionally substituted mono- or polycyclic aromatic carbocyclic moiety, e.g., about 6 to about 60 carbon atoms, such as phenyl, naphthyl or fluorenyl; or, (ii) an optionally substituted partially saturated polycyclic carbocyclic aromatic ring system in which an aryl and a cycloalkyl or cycloalkenyl group are fused together to form a cyclic structure such as a tetrahydronaphthyl, indenyl, indanyl or fluorene ring.
“Heterocyclyl” or “heterocyclic” whether used alone, or in compound words such as heterocyclyloxy refers to: (i) an optionally substituted cycloalkyl or cycloalkenyl group, e.g., about 3 to about 60 ring members, which can contain one or more heteroatoms such as nitrogen, oxygen, or sulfur (examples include pyrrolidinyl, morpholino, thiomorpholino, or fully or partially hydrogenated thienyl, furyl, pyrrolyl, thiazolyl, oxazolyl, oxazinyl, thiazinyl, pyridyl and azepinyl); (ii) an optionally substituted partially saturated polycyclic ring system in which an aryl (or heteroaryl) ring and a heterocyclic group are fused together to form a cyclic structure (examples include chromanyl, dihydrobenzofuryl and indolinyl); or (iii) an optionally substituted fully or partially saturated polycyclic fused ring system that has one or more bridges (examples include quinuclidinyl and dihydro-1,4-cpoxynaphthyl).
“Heteroaryl” or “hetaryl” whether used alone, or in compound words such as heteroaryloxy refers to: (i) an optionally substituted mono- or polycyclic aromatic organic moiety, e.g., about 1 to about 10 ring members in which one or more of the ring members is/are element(s) other than carbon, for example nitrogen, oxygen, sulfur or silicon; the heteroatom(s) interrupting a carbocyclic ring structure and having a sufficient number of delocalized pi electrons to provide aromatic character, provided that the rings do not contain adjacent oxygen and/or sulfur atoms. Typical 6-membered heteroaryl groups are pyrazinyl, pyridazinyl, pyrazolyl, pyridyl and pyrimidinyl. All regioisomers are contemplated, e.g., 2-pyridyl, 3-pyridyl and 4-pyridyl. Typical 5-membered heteroaryl rings are furyl, imidazolyl, oxazolyl, isoxazolyl, isothiazolyl, oxadiazolyl, pyrrolyl, 1,3,4-thiadiazolyl, thiazolyl, thienyl, triazolyl, and silole. All regioisomers are contemplated, e.g., 2-thienyl and 3-thienyl. Bicyclic groups typically are benzo-fused ring systems derived from the heteroaryl groups named above, e.g., benzofuryl, benzimidazolyl, benzthiazolyl, indolyl, indolizinyl, isoquinolyl, quinazolinyl, quinolyl and benzothienyl; or, (ii) an optionally substituted partially saturated polycyclic heteroaryl ring system in which a heteroaryl and a cycloalkyl or cycloalkenyl group are fused together to form a cyclic structure such as a tetrahydroquinolyl or pyrindinyl ring.
“Formyl” refers to a —CHO moiety.
“Alkanoyl” refers to a —C(O)-alkyl group in which the alkyl group is as defined above. An alkanoyl group can range in size from about C₂-C₂₀. One example is acyl.
“Aroyl” refers to a —C(O)-aryl group in which the aryl group is as defined above. An aroyl group can range in size from about C₇-C₂₀. Examples include benzoyl and 1-naphthoyl and 2-naphthoyl.
“Heteroaroyl” refers to a —C(O)-heteroaryl group in which the heteroaryl group is as defined above. A heteroaroyl group can range in size from about C₆-C₂₀. An example is pyridylcarbonyl.
“Carboxyl” refers to a —CO₂H moiety.
“Oxycarbonyl” refers to a carboxylic acid ester group —CO₂R which is linked to the rest of the molecule through a carbon atom.
“Alkoxycarbonyl” refers to a —CO₂-alkyl group in which the alkyl group is as defined above. An alkoxycarbonyl group can range in size from about C₂-C₂₀. Examples include methoxycarbonyl and ethoxycarbonyl.
“Aryloxycarbonyl” refers to a —CO₂-aryl group in which the aryl group is as defined above. Examples include phenoxycarbonyl and naphthoxycarbonyl.
“Heterocyclyloxycarbonyl” refers to a —CO₂-heterocyclyl group in which the heterocyclic group is as defined above.
“Heteroaryloxycarbonyl” refers to a —CO₂-heteroaryl group in which the heteroaryl group is as defined above.
“Aminocarbonyl” refers to a carboxylic acid amide group —C(O) NHR or —C(O)NR₂ which is linked to the rest of the molecule through a carbon atom.
“Alkylaminocarbonyl” refers to a —C(O)NHR a —C(O)NR₂ group in which R is an alkyl group as defined above.
“Arylaminocarbonyl” refers to a —C(O)NHR a —C(O)NR₂ group in which R is an aryl group as defined above.
“Heterocyclylaminocarbonyl” refers to a —C(O)NHR a —C(O)NR₂ group in which R is a heterocyclic group as defined above. NR₂ can for example be a heterocyclic ring, which is optionally substituted.
“Heteroarylaminocarbonyl” refers to a —C(O)NHR a —C(O)NR₂ group in which R is a heteroaryl group as defined above. NR₂ can for example be a heteroaryl ring, which is optionally substituted.
“Cyano” refers to a —CN moiety.
“Hydroxyl” refers to an —OH moiety.
“Alkoxy” refers to an —O-alkyl group in which the alkyl group is as defined above. Examples include methoxy, ethoxy, n-propoxy, iso-propoxy, and the different butoxy, pentoxy, hexyloxy and higher isomers.
“Aryloxy” refers to an —O-aryl group in which the aryl group is as defined above. Examples include, without limitation, phenoxy and naphthoxy.
“Alkenyloxy” refers to an —O-alkenyl group in which the alkenyl group is as defined above. An example is allyloxy.
“Heterocyclyloxy” refers to an —O-heterocyclyl group in which the heterocyclic group is as defined above.
“Heteroaryloxy” refers to an —O-heteroaryl group in which the heteroaryl group is as defined above. An example is pyridyloxy.
“Alkanoate” refers to an —OC(O)—R group in which R is an alkyl group as defined above.
“Aryloate” refers to an —OC(O)—R group in which R is an aryl group as defined above.
“Heterocyclyloate” refers to an —OC(O)—R group in which R is a heterocyclic group as defined above.
“Heteroaryloate” refers to an —OC(O)—R group in which P is a heteroaryl group as defined above.
“Amino” refers to a —NH₂ moiety.
“Alkylamino” refers to a —NHR or —NR₂ group in which R is an alkyl group as defined above. Examples include, without limitation, methylamino, ethylamino, n-propylamino, isopropylamino, and the different butylamino, pentylamino, hexylamino and higher isomers.
“Arylamino” refers to a —NHR or —NR₂ group in which R is an aryl group as defined above. An example is phenylamino.
“Heterocyclylamino” refers to a —NHR or —NR₂ group in which R is a heterocyclic group as defined above. NR₂ can for example be a heterocyclic ring, which is optionally substituted.
“Heteroarylamino” refers to a —NHR or —NR₂ group in which R is a heteroaryl group as defined above. NR₂ can for example be a heteroaryl ring, which is optionally substituted.
“Carbonylamino” refers to a carboxylic acid amide group —NHC(O)R that is linked to the rest of the molecule through a nitrogen atom.
“Alkylcarbonylamino” refers to a —NHC(O)R group in which R is an alkyl group as defined above.
“Arylcarbonylamino” refers to a —NHC(O)R group in which R is an aryl group as defined above.
“Heterocyclylcarbonylamino” refers to a —NHC(O)R group in which R is a heterocyclic group as defined above.
“Heteroarylcarbonylamino” refers to an —NHC(O)R group in which R is a heteroaryl group as defined above.
“Nitro” refers to a —NO₂ moiety.
“Alkenylsilyl” refers to an alkenyl group that is linked to the molecule through a silicon atom, which can be substituted with up to three independently selected alkenyl groups in which each alkenyl group is as defined above.
“Alkynylsilyl” refers to an alkynyl group that is linked to the molecule through the silicon atom, which can be substituted with up to three independently selected alkynyl groups in which each alkenyl group is as defined above.

The term “halo” or “halogen” refers to fluorine, chlorine, bromine or iodine. Further, when used in compound words such as haloalkyl, haloalkoxy or haloalkylsulfonyl, the alkyl can be partially halogenated or fully substituted with halogen atoms which can be independently the same or different. Examples of haloalkyl can include —CH₂CH₂F, —CF₂CF₃ and —CH₂CHFCl. Examples of haloalkoxy can include —OCHF₂, —OCF₃, —OCH₂CCl₃, —OCH₂CF₃ and —OCH₂CH₂CF₃. Examples of haloalkylsulfonyl can include —SO₂CF₃, —SO₂CCl₃, —SO₂CH₂CF₃ and —SO₂CF₂CF₃.

The terms “thiol”, “thio”, “mercapto” or “mercaptan” refer to any organosulphur group containing a sulphurhydryl moiety —SH, which includes a R—SH group where R is a moiety containing a carbon atom for coordination to the —SH moiety, for example an alkylsulphur group as defined above. For example, the thiol or mercapto group can be a sulphurhydryl moiety —SH.

The terms “thione”, “thioketones” or “thiocarbonyls” refer to any organosulphur group containing a —C═S moiety, which includes a R—C═S group, for example where R is an alky group defined above. For example, the thione group can be a —C═S moiety.

The term “exocyclic” refers to an atom or group that is attached externally to a cyclic ring system of a heteroaryl or heterocyclic compound, which contrasts with an “endocyclic” atom or group that is within the ring system such that the atoms form a part of the ring system of the heteroaryl or heterocyclic compound.

The compounds described herein can include salts, solvates, hydrates, isomers, tautomers, racemates, stereoisomers, enantiomers or diastereoisomers of those compounds. For example salts can include sodium, potassium, calcium, nitrates, phosphates, sulphates, and chlorides. In one aspect the compounds include salts thereof selected from sodium salts.

### Corrosion Inhibiting Agents

The corrosion inhibiting agents of the present disclosure can be selected from at least one organic heterocyclic compound comprising at least one exocyclic sulphur group, for example a thiol or thione group. The corrosion inhibiting agents of the present disclosure can also be selected from at least one organic heterocyclic compound comprising a single exocyclic sulphur group, for example a thiol or thione group. The organic heterocyclic compounds can be each optionally substituted and optionally fused with one or more substituents or groups. The organic heterocyclic compounds can be selected from an optionally substituted, optionally fused, heteroaryl or heterocyclic compound comprising at least one exocyclic thiol or thione group. The organic heterocyclic compound can be selected from optionally substituted heteroaryl or heterocyclic compound comprising at least one exocyclic thiol or thione group and at least one endocyclic heteroatom selected from N, O and S. The organic heterocyclic compound can include salts of the at least one exocyclic thiol groups, for example, thiol sodium salt.

The one or more organic heterocyclic compounds can each be selected from an optionally substituted, optionally fused, 5 or 6-membered mono or bicyclic heteroaryl or heterocyclic compound comprising at least one exocyclic sulphur group selected from a thiol and thione. The exocyclic sulphur group can be a thiol.

The at least one organic heterocyclic compound can be selected from a compound of Formula 1 or salt thereof:

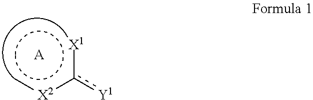

in which,
A is a 5- or 6-membered aryl, heteroaryl or heterocyclic ring, which is optionally substituted with one or more substituents and optionally fused with one or more aryl or heteroaryl rings, in which a dotted line represents one or more optional double bonds;
Y¹ is selected from S or SH, in which a dotted line represents a double bond when Y¹ is S or is absent when Y¹ is SH;
X¹ is selected from N, NH, O, and S;
X² is selected from N, NR⁵, O, S, CR⁶ and CR⁷R⁸;
R⁵ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and
R⁶, R⁷ and R⁸, are each independently selected from hydrogen, halo, thiol, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted.

For the organic heterocyclic compounds of Formula 1, Y¹ can be SH. X¹ can be selected from N, NH, and S. X¹ can be selected from N and S. X¹ can be selected from N and NH. X² can be selected from N, NH, O, and S. X² can be selected from N, NH, and S. X² can be selected from N and NH. X¹ and X² can be each independently selected from N, NH and S. X¹ and X² can be each independently selected from N and NH. X¹ can be selected from N and NH, and X² can be selected from CR⁶ and CR⁷R⁸.

For the organic heterocyclic compounds of Formula 1, Y¹ can be SH, and X¹ and X² can each be independently selected from N, NH, and S. X¹ can be further selected from N and S. X¹ can be further selected from N and NH. X² can be further selected from CR⁶ and CR⁷R⁸. X² can be further selected from N, NH, and S. X² can be further selected from N and NH. X¹ and X² each can be further independently selected from N and NH.

Optionally fused groups of ring A can be monocyclic or polycyclic. Optional fused groups of the A can be optionally substituted mono- or bicyclic aryl, heteroaryl or heterocyclic ring, for example where a compound of Formula 1 is a bicyclic compound. The monocyclic aryl groups can be an optionally substituted 6 membered ring, such as benzene. The polycyclic aryl groups can be two or more optionally substituted 6-member rings fused together, such as naphthalene, anthracene, pyrene, tetracene, and pentacene. The heteroaryl groups can be selected from 5-membered monocyclic rings, such as thiophene, furan, pyrrole, silole, imidazole, 1,3-thiazole, 1,3,4-oxadiazole, 1,3,4-thiadiazole, or 6 membered rings, such as pyridine and triazine, in which each ring can be optionally substituted.

Optional substituents of A can be selected from halo, cyano, amino, hydroxy, alkanoic acid, alkanoate salt, carbamoyl, C₁-C₁₀ alkyloxycarbonyl, C₁-C₁₀ alkyl, C₁-C₁₀ haloalkyl, C₁-C₁₀ alkylamino, C₃-C₁₀ cycloalkyl, C₂-C₁₀ alkenyl, C₃-C₁₀ cycloalkenyl, C₂-C₁₀ alkynyl, C₃-C₁₀ cycloalkynyl, C₁-C₁₀ heteroaryl, C₁-C₁₀alkyloxy, C₃-C₁₀ cycloalkyloxy and in which amino, alkanoic acid, alkanoic salt, alkyloxycarbonyl, alkyl, haloalkyl, alkylamino, cycloalkyl, alkenyl, cycloalkenyl, alkynyl, cycloalkynyl, aryl, arylalkyl, heteroaryl, heteroarylalkyl, alkyloxy and cycloalkyloxy in each occurrence can be optionally substituted. For example, the optional substitution can be one or more of halo, hydroxyl, amino, nitro, carboxylic acid. The optional substitution can be any one or more groups selected from halo, alkyl, formyl, and amino. The optional substituents can include salts of the functional groups, for example carboxylate salts.

Ring A can be heterocyclic, e.g., an unsaturated heterocyclic compound. Ring A can be heteroaromatic or partially unsaturated. For example, ring A can contain one or more double bonds between ring atoms. Ring A can also contain one or more optional substituents and optional fused groups. Ring A can be a monocyclic 5 or 6 membered heteroaryl or heterocyclic ring. Ring A can be a bicyclic ring comprising two rings joined together that are each independently selected from 5 and 6 membered rings. Ring A can be a bicyclic ring comprising two rings fused together that are each independently selected from 5 and 6 membered rings. Ring A can be a bicyclic heteroaryl or heterocyclic ring containing a 5 membered heterocyclic ring fused to a 6 membered aryl, carbocyclic, heterocyclic or heteroaryl ring.

The at least one organic heterocyclic compound can be selected from a compound of Formula 1(a) or salts thereof:

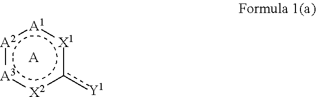

in which,
A, Y¹, X¹ and X² are defined according to Formula 1 as described above;
A¹, A² and A³ are each independently selected from C═O, C═S, N, NR¹³, O, S, SO₂, CR¹⁴, CR¹⁵R¹⁶;
R¹³ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and
R¹³, R¹⁴, R¹⁵ and R¹⁶, are each independently selected from hydrogen, halo, thiol, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted, and optionally two of R¹³, R¹⁴, R¹⁵ and R¹⁶, join together to form an optionally substituted aryl or heteroaryl ring fused to A.

In at least one aspect, A¹ and A³ are CR¹⁴. In another aspect, R¹⁴ is selected from amino and thiol. In another aspect, A¹ and A³ are each independently selected from C—SH and C—NH₂. In another aspect, A¹ and A³ are C—SH. In some aspects, Y¹ is SH. In another aspect, X¹ and X² are N. In another aspect, A² is N. For example, compounds of Formula 1(a) can include:

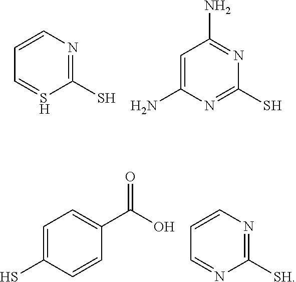

The at least one organic heterocyclic compound can be selected from a compound of Formula 1(a)(i) or salts thereof:

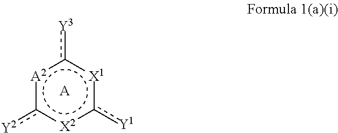

in which,
A is a 5- or 6-membered aryl, heteroaryl or heterocyclic ring, which is optionally substituted with one or more substituents and optionally fused with one or more aryl or heteroaryl rings, in which a dotted line represents one or more optional double bonds;
A², X¹ and X² are each independently selected from N, NH, O, and S;
Y¹, Y² and Y³ are each independently selected from S or SH, in which the dotted line represents a double bond when Y¹ is S or is absent when Y¹ is SH;
A¹ and A³ are each independently selected from C═O, C═S, N, NR¹³, O, S, SO₂, CR¹⁴, CR¹⁵R¹⁶; and
R¹³, R¹⁴, R¹⁵ and R¹⁶ are defined according to Formula 1a as described above.

In at least one aspect, A², X¹ and X² are N. In another aspect, Y¹, Y² and Y³ are SH.

For example, compounds of Formula 1(a)(i) can include:

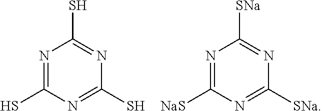

In one aspect, the at least one organic heterocyclic compound can be selected from a compound of Formula 1(b) or salt thereof:

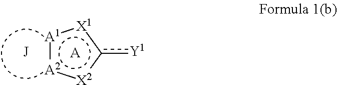

in which,
A is an optionally substituted 5-membered heterocyclic ring, in which a dotted line represents one or more optional double bonds;
X¹, X² and Y¹ are defined according to Formula 1 as described above;
A¹ and A² are each independently selected from C═O, C═S, N, NR¹³, O, S, SO₂, CR¹⁴ and CR¹⁵R¹⁶; and are optionally joined together to form an optionally substituted aryl, heteroaryl or heterocyclic ring J that is fused to A;
R¹³ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and

R¹⁴, R¹⁵ and R¹⁶, are each independently selected from hydrogen, halo, amino, C₁-C₁₀alkyl, C₂-C₁₀alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted, and optionally two of R¹³, R¹⁴, R¹⁵ and R¹⁶, join together to form an optionally substituted aryl or heteroaryl ring fused to A.

For example, compounds of Formula 1(b) can include:

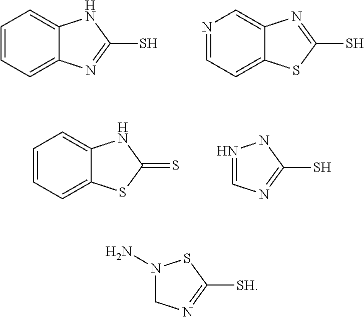

The at least one organic heterocyclic compound can be selected from a compound of Formula 1(b)(i) or salt thereof:

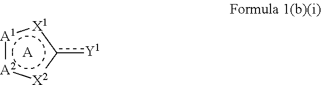

in which,
A is an optionally substituted 5-membered heterocyclic ring, in which a dotted line represents one or more optional double bonds;
X¹, X² and Y¹ are defined according to Formula 1b as described above;
A¹ and A² are each independently selected from N, NR¹³, O, S, CR¹⁴ and CR¹⁵R¹⁶;
R¹³ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and
R¹⁴, R¹⁵ and R¹⁶ are defined according to Formula 1b as described above.

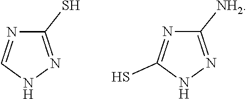 [SMILES: Sc1nc[nH]n1 ; Nc1n[nH]c(S)n1]

For example, compounds of Formula 1(b)(i) can include:

The at least one organic heterocyclic compound can be selected from a compound of Formula 1(b)(ii) or salt thereof:

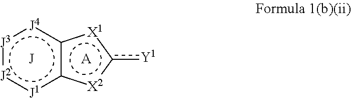

in which,
A is an optionally substituted 5-membered heterocyclic ring and J is an optionally substituted 6-membered aryl or heterocyclic ring, in which a dotted line represents one or more optional double bonds;
X¹, X² and Y¹ are defined according to Formula 1a as described above;
J¹, J², J³ and J⁴ are each independently selected from N, NR¹³, O, S, CR¹⁴ and CR¹⁵R¹⁶;
R¹³ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and
R¹⁴, R¹⁵ and R¹⁶, are each independently selected from hydrogen, halo, amino, C₁-C₁₀alkyl, C₂-C₁₀alkenyl, C₂-C₁₀alkynyl, C₂-C₁₀ aryl, and C₂-C₁₀ heteroaryl, in which each amino, alkyl, alkenyl, alkynyl, aryl or heteroaryl group can be optionally substituted.

For example, compounds of Formula 1(b)(ii) can include:

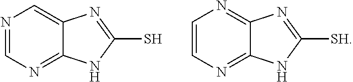 [SMILES: Sc1nc2cncnc2[nH]1 ; Sc1nc2nccnc2[nH]1]

It will be appreciated that any of the aspects or examples described above or herein for Formula 1 can also provide aspects for any compounds of Formula 1(a), 1(a)(i), 1(b), 1(b)(i) or 1(b)(ii).

The organic compounds can exist as one or more stereoisomers. The various stereoisomers can include enantiomers, diastereomers and geometric isomers. Those skilled in the art will appreciate that one stereoisomer can be more active than the other(s). In addition, the skilled person would know how to separate such stereoisomers. Accordingly, the present disclosure includes mixtures, individual stereoisomers, and optically active mixtures of the compounds described herein.

For example, heteroaryl and heterocyclic organic compounds of Formula 1 can include the compounds as shown below in Table 1.

TABLE 1

| Ref. No. | Chemical Name | Chemical Structure |
|---|---|---|
| 1 | 2- mercaptobenzimidazole (MBI) | 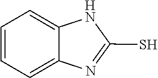 |
| 2 | 3a,4-dihydrothiazolo[4,5- c]pyridine-2-thiol | 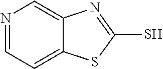 |
| 3 | benzo[d]thiazole-2(3H)- thione | 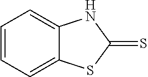 |
| 4 | 1,2,4-triazole-3-thiol | 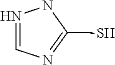 |
| 5 | 2-amino,5-mercapto- 1,2,4-thiadiazole | 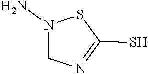 |
| 6 | 5-methyl-2-mercapto- 1,3,4-thiadazole | 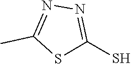 |
| 7 | 4-amino-5-phenyl-3- mercapto-1,2,4-triazole | 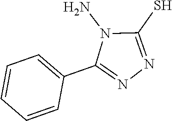 [SMILES: Nn1c(S)nnc1-c1ccccc1] |
| 8 | 5-mercapto-1-tetrazole- 1H-acetic acid, sodium salt | 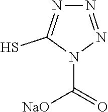 |
| 9 | 4,6-diamino-2- mercaptopyrimidine | 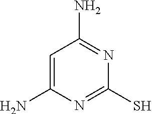 |
| 10 | 4-amino-2- mercaptopyrimidine | 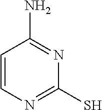 |
| 11 | 2,6-diamino-4- mercaptopyrimidine | 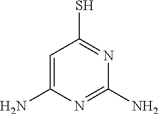 |
| 12 | 9H-purine-8-thiol | 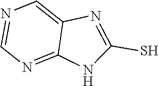 |
| 13 | 1H-imidazo[4,5- b]pyrazine-2-thiol | 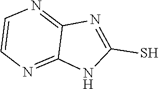 |
| 14 | S-triazolo-[4,3-a]- pyridine-3-thione | 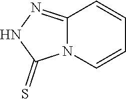 |
| 15 | 2- mercaptobenzimidazole | 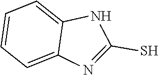 |
| 16 | 1,2,4-triazole-3-thiol | 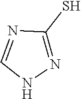 |
| 17 | 3-amino-5-mercapto- 1,2,4,-triazole | 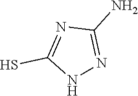 |
| 18 | 2-mercaptopyrimidine | 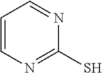 |
| 19 | 2-mercaptonicotinate, sodium salt | 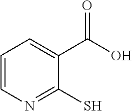 |
| 20 | 4-mercaptobenzoate, sodium salt | 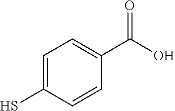 |
| 21 | 6-mercaptonicotinate, sodium salt | 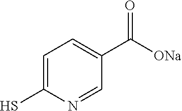 |
| 22 | 1,3,5-triazine-2,4,6- trithiol | 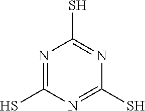 |
| 23 | 1,3,5-triazine-2,4,6- trithiol, trisodium salt | 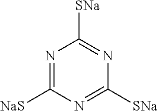 |

### Metal Salts

The metal salts or mixed metal salts of the corrosion inhibiting compositions can be selected from alkali earth metals, transition metals and rare earth metal salts, for example a group consisting of Zn, La, Pr, Nd, Sm, Eu, Gd, Tb, Dy, Ho, Er, Tm, Yb, Lu, Ce, Co, Y, Bi, Cd, Pb, Ag, Sb, Sn, Cu, Fe, Ni, Li, Ca, Sr, Mg, Zr, Nd, Ba, Sc, and any combinations thereof. The corrosion inhibitor compositions can comprise at least one metal salt or mixed metal salt, in which the metal is selected from the group consisting of Zn, La, Pr, Ce, Co, Y, Ca, Sr, Ba, Sc, and Zr. It will be appreciated that a mixed metal salt can be provided by a combination comprising two or more metals. For example, the mixed metal salt can comprise two or more metals selected from any two or more of Zn, La, Pr, Nd, Sm, Eu, Gd, Tb, Dy, Ho, Er, Tm, Yb, Lu, Ce, Co, Y, Bi, Cd, Pb, Ag, Sb, Sn, Cu, Fe, Ni, Li, Ca, Sr, Mg, Zr, Nd, Ba, and Sc. The metals can be selected from at least one of Zn, Pr and Ce. The metal can be Zn. The metal can be Ce. The metal can be Pr. For example, the salts can include nitrate, chloride and acetate salts. In at least one aspect, the metals can have different oxidation states. For example, the oxidation state for Zn can be +2. For example, the oxidation state for Pr can be +2, +3 or +4. For example, the oxidation state for Ce can be +2, +3, or +4. It will be appreciated that various combinations and groups of the above mentioned metal salts or mixed metal salts, can be used in the compositions of the present disclosure.

### Substrates

Substrates that can be protected from corrosion by the corrosion inhibiting agents or compositions thereof as described herein can be metal substrates. The metal substrate can include any substrate material having at least a metallic portion on a surface. For example, the surface can be an external surface of a metal substrate that is exposed to environmental conditions compared to an internal surface of a metal substrate. The metal substrate can comprise any metal requiring protection from corrosion. The metal substrate can comprise a metal or alloy including aluminium. The metal substrate can be an aluminium alloy, e.g., alloys of aluminium with one or more metals selected from the group consisting of copper, magnesium, manganese, silicon, tin and zinc. The aluminium alloys can be an alloy comprising copper. The metal substrate can be a copper-containing alloy, such as copper-containing aluminium alloy. The amount of copper in the alloy can be less than about 20%, less than about 18%, less than about 16%, less than about 14%, less than about 12%, less than about 10%, less than about 8%, or less than about 6%. The aluminium alloy can be an aerospace alloy, for example AA2XXX and AA7XXX type. For example, the aluminium alloy can be AA2024 and AA7075 type. The aluminium alloy can be an automotive alloy, for example AA6XXX type. The aluminium alloy can be a marine alloy, for example AA5XXX type.

### Metal Organic Frameworks (MOFs)

In at least one aspect, the MOFs can be one-, two- or three-dimensional structures provided by an organometallic framework comprising a plurality of metal ions each coordinated to one or more organic ligands. In at least one aspect, a metal ion can include a free metal ion or a metal ion can be present as a plurality of metal ions as part of a metal cluster. MOFs can provide porous structures comprising a plurality of pores. The MOFs can be crystalline or amorphous, for example the one-, two- or three-dimensional MOF structures can be amorphous or crystalline. In at least one aspect, the metal clusters can include two or more metal ions linked in part by metal-metal bonds. In at least one aspect, one dimensional structures can include a linear structure of metal atoms linked by organic ligands. In at least one aspect, two dimensional structures can include a sheet or layer structure having length and width (e.g. area) dimensions of metal atoms linked by organic ligands. In at least one aspect, three dimensional structures can include a sphere or cube structure having length, width and height (e.g. volume) dimensions of metal atoms linked by organic ligands. The one-, two- or three-dimensional MOF structures can be at least partially amorphous or at least partially crystalline, e.g., a MOF having regions of order providing a degree of crystallinity and regions of disorder providing amorphous properties. In at least one aspect, the MOFs can be two-dimensional and/or three-dimensional structures. In at least one aspect, the MOFs can be crystalline, and can include an appropriate amount of homogeneity.

In at least one aspect, the organic ligands of the MOFs can be selected from heterocyclic compounds, which may be optionally substituted and optionally fused with one or more substituents or groups. In at least one aspect, the metal organic frameworks can incorporate other ligands with the metals or metal clusters in addition to the organic ligands, for example anions such as acetate or halides may provide additional ligands, and for example may originate from metal salts used to form the MOFs.

In another aspect, the MOFs include a plurality of molecular building blocks (MBB) each having a metal cluster that together with one or more organic ligands forms secondary building units (SBU) that are each connected together into a network. The configuration and connection of SBUs into a framework can be described by topologies that are also called a “net”, which are commonly assigned three letter symbols (e.g. “pcu net”) as provided in the database of Reticular Chemistry Structure Resource. The MOFs may be based on single metals as vertices in the framework.

The MOFs can be solid particles that are suitable for dispersion in compositions. In at least one aspect, the average diameter of the MOF particles is about 20 nm to about 50 μm as measured by ASTM F1372-93 and/or ASTM D6281-98, about 40 nm to about 30 μm, about 60 nm to about 10 μm, about 80 nm to about 5 μm, or about 100 nm to about 1 μm. For example, the average diameter of the MOF particles can be about 100 nm to about 1 μm.

### Compositions and Formulations

The present disclosure relates to compositions for inhibiting corrosion comprising at least one organic heterocyclic compound of Formula 1 with a metal selected from rare earth, alkali earth and transition metals, a sealant comprising a non-stoichiometric sensitive composition, and an activator.

In at least one aspect, the MOF structure can be designed with organic ligands as cathodic inhibitors binding to the intermetallics, while the metal ions form passivation layers. In at least one aspect, the corrosion inhibitor compositions can comprise at least one organic heterocyclic compound of Formula 1 as described herein or any aspects thereof, at least one metal salt or mixed metal salt, in which the metal is selected from the group consisting of Zn, La, Pr, Ce, Nd, Sm, Eu, Gd, Tb, Dy, Ho, Er, Tm, Yb, Lu, Co, Y, Ca, Sr, Ba, Sc, Zr, and combinations thereof, and at least one sealant comprising a non-stoichiometric sensitive composition, e.g., a polythioether, polyurethane, and/or polysulfide, and an activator, e.g., manganese. For example, the at least one metal can be any one of Zn, Ce and Pr; the at least one metal can be Zn; the at least one metal can be Ce; or the at least one metal can be Pr. As a further example, the non-stoichiometric sensitive composition can be polysulfide, e.g., polysulfide manganese.

The corrosion inhibitor composition can comprise at least one organic heterocyclic compound of Formula 1(a) or salt thereof, as described herein or any aspects thereof at least one metal salt or mixed metal salt, in which the metal is selected from the group consisting of Zn, La, Pr, Ce, Nd, Sm, Eu, Gd, Tb, Dy, Ho, Er, Tm, Yb, Lu, Co, Y, Ca, Sr, Ba, Sc, Zr, and combinations thereof, and at least one sealant comprising a non-stoichiometric sensitive composition, e.g., a polythioether, polyurethane, and/or polysulfide, and an activator, e.g., manganese. For example, the at least one metal can be any one of Zn, Ce and Pr; the at least one metal can be Zn; the at least one metal can be Ce; or the at least one metal can be Pr. As a further example, the non-stoichiometric sensitive composition can be polysulfide, e.g., polysulfide manganese.

The corrosion inhibitor composition can comprise at least one organic heterocyclic compound of Formula 1(a)(i) or salt thereof, as described herein or any aspects thereof at least one metal salt or mixed metal salt, in which the metal is selected from the group consisting of Zn, La, Pr, Ce, Nd, Sm, Eu, Gd, Tb, Dy, Ho, Er, Tm, Yb, Lu, Co, Y, Ca, Sr, Ba, Sc, Zr, and combinations thereof, and at least one sealant comprising a non-stoichiometric sensitive composition, e.g., a polythioether, polyurethane, and/or polysulfide, and an activator, e.g., manganese. For example, the at least one metal can be any one of Zn, Ce and Pr; the at least one metal can be Zn; the at least one metal can be Ce; or the at least one metal can be Pr. As a further example, the non-stoichiometric sensitive composition can be polysulfide, e.g., polysulfide manganese.

The corrosion inhibitor composition can comprise at least one organic heterocyclic compound of Formula 1(b) or salt thereof, as described herein or any aspects thereof at least one metal salt or mixed metal salt, in which the metal is selected from the group consisting of Zn, La, Pr, Ce, Nd, Sm, Eu, Gd, Tb, Dy, Ho, Er, Tm, Yb, Lu, Co, Y, Ca, Sr, Ba, Sc, Zr, and combinations thereof, and at least one sealant comprising a non-stoichiometric sensitive composition, e.g., a polythioether, polyurethane, and/or polysulfide, and an activator, e.g., manganese. For example, the at least one metal can be any one of Zn, Ce and Pr; the at least one metal can be Zn; the at least one metal can be Ce; or the at least one metal can be Pr. As a further example, the non-stoichiometric sensitive composition can be polysulfide, e.g., polysulfide manganese.

The corrosion inhibitor composition can comprise at least one organic heterocyclic compound of Formula 1(b)(i) or salt thereof, as described herein or any aspects thereof at least one metal salt or mixed metal salt, in which the metal is selected from the group consisting of Zn, La, Pr, Ce, Nd, Sm, Eu, Gd, Tb, Dy, Ho, Er, Tm, Yb, Lu, Co, Y, Ca, Sr, Ba, Sc, Zr, and combinations thereof, and at least one sealant comprising a non-stoichiometric sensitive composition, e.g., a polythioether, polyurethane, and/or polysulfide, and an activator, e.g., manganese. For example, the at least one metal can be any one of Zn, Ce and Pr; the at least one metal can be Zn; the at least one metal can be Ce; or the at least one metal can be Pr. As a further example, the non-stoichiometric sensitive composition can be polysulfide, e.g., polysulfide manganese.

The corrosion inhibitor composition can comprise at least one organic heterocyclic compound of Formula 1(b)(ii) or salt thereof, as described herein or any aspects thereof at least one metal salt or mixed metal salt, in which the metal is selected from the group consisting of Zn, La, Pr, Cc, Nd, Sm, Eu, Gd, Tb, Dy, Ho, Er, Tm, Yb, Lu, Co, Y, Ca, Sr, Ba, Sc, Zr, and combinations thereof, and at least one sealant comprising a non-stoichiometric sensitive composition, e.g., a polythioether, polyurethane, and/or polysulfide, and an activator, e.g., manganese. For example, the at least one metal can be any one of Zn, Ce and Pr; the at least one metal can be Zn; the at least one metal can be Ce; or the at least one metal can be Pr. As a further example, the non-stoichiometric sensitive composition can be polysulfide, e.g., polysulfide manganese. In at least one aspect, the coating composition can include a weight ratio of corrosion inhibitor to sealant of about 1:100 to about 100:15, e.g., about 1:100 to about to about 1:10, about 1:10 to about 1:2, about 1:2 to about 2:1, about 2:1 to about 10:1, about 10:1 to about 100:1, or about 100:1 to about 100:15. Further advantages can be achieved in which the concentration of the corrosion inhibiting agents and metal salts or mixed metal salts are provided at various concentration and ratio ranges, e.g., about 1:100 to about to about 1:10, about 1:10 to about 1:2, about 1:2 to about 2:1, about 2:1 to about 10:1, about 10:1 to about 100:1, or about 100:1 to about 100:15. In at least one aspect, the coating composition can include about 1 wt % to about 15 wt % of corrosion inhibitor to sealant of the total composition, e.g., about 1 wt % to about 5 wt %, about 5 wt % to about 10 wt %, or about 10 wt % to about 15 wt %.

The concentration of the corrosion inhibiting agent when used in combination with a metal salt or mixed metal salt can be greater than 5×10⁻¹ M, greater than 2×10⁻¹ M, greater than 10⁻¹ M, greater than 5×10⁻² M, greater than 2×10⁻² M, greater than 10⁻² M, greater than 5×10⁻³ M, greater than 2×10⁻³ M, or greater than 10⁻³ M.

In one aspect, the weight ratio of corrosion inhibiting agent:metal salt in the corrosion inhibitor composition is provided with an excess of the corrosion inhibiting agent in comparison to the metal salt. For example, the weight ratio of corrosion inhibiting agent:metal salt in the corrosion inhibitor composition can be greater than about 1:1, greater than about 1.1:1, greater than about 1.2:1, greater than about 1.3:1, greater than about 1.4:1, greater than about 1.5:1, greater than about 1.6:1, greater than about 1.7:1, greater than about 1.8:1, greater than about 1.9:1, greater than about 2:1, greater than about 3:1, greater than about 4:1, greater than about 5:1, greater than about 6:1, greater than about 7:1, greater than about 8:1, greater than about 9:1, or greater than about 10:1. The weight ratio of corrosion inhibiting agent: metal salt in the corrosion inhibitor composition can be less than about 45:1, less than about 40:1, less than about 35:1, less than about 30:1, less than about 25:1, less than about 20:1, less than about 15:1, or less than about 10:1. The weight ratio of corrosion inhibiting agent:metal salt in the corrosion inhibitor composition can be provided in a range of greater than about 1:1 to about 45:1, about 1.5:1 to about 40:1, about 2:1 to about 35:1, about 2.5:1 to about 30:1, about 3:1 to about 25:1, about 3.5:1 to about 20:1, about 4:1 to about 15:1, or about 5:1 to about 10:1. For example, the weight ratio of corrosion inhibiting agent: metal salt in the corrosion inhibitor composition can be provided in a range of about 1.1:1 to about 45:1, about 1.2:1 to about 40:1, about 1.3:1 to about 35:1, about 1.4:1 to about 30:1, about 1.5:1 to about 25:1, about 1.6:1 to about 20:1, about 1.7:1 to about 15:1, about 1.8:1 to about 10:1, about 1.9:1 to about 9:1, or about 2:1 to about 8:1.

The MOFs can be formed as solid particles that are suitable for dispersion in compositions. In at least one aspect, the average diameter of the MOF particles is in a range of 20 nm to 50 μm, 40 nm to 30 μm, 60 nm to 10 μm, 80 nm to 5 μm, or 100nm to 1 μm as measured by ASTM F1372-93 and/or ASTM D6281-98. In one aspect, the average diameter of the MOF particles is in a range of 100 nm to 1 μm.

The corrosion inhibitor compositions are suitable for use and application to various substrates, such as metal substrates, and for example can be provided as coating compositions. The compositions can include one or more other additives or corrosion inhibiting agents suitable for particular use with a type of substrate.

The corrosion inhibiting composition can be a coating composition comprising a film-forming organic material. The coating composition includes a sealant. The sealant can include a non-stoichiometric sensitive composition, e.g., a polysulfide composition. In at least one aspect, the polysulfide composition can include a polysulfide manganese cured composition. Without being bound by theory, a non-stoichiometric sensitive composition may stabilize the MOF inhibitor as a non-stoichiometric sensitive composition can be more tolerant of reactant ratios as compared to conventional sealant compositions, e.g., polythioether compositions and/or polyurethane compositions. A tolerant sealant composition can reduce production costs and allow for a greater concentration of corrosion inhibitors, e.g., MOFS, without agglomeration.

The coating composition can be a paint composition. The coating composition can comprise one or more resins, for example epoxy based resins. The coating composition can be a paint composition, for example an epoxy resin based paint composition.

The coating composition can be a powder coating composition, for example a powder coating composition suitable for use in powder coating of various metal substrates including aluminium alloys as described herein or steels.

The coating composition can be a spray composition.

The coating compositions can be applied to a substrate, in either a wet or “not fully cured” condition that dries or cures over time, that is, solvent evaporates. The coatings can dry or cure either naturally or by accelerated means, for example an ultraviolet light cured system to form a film or “cured” paint. The coatings can also be applied in a semi or fully cured state, such as an adhesive. The coatings can be thixotropic, where a thixotropic coating may include a coating that becomes less viscous when loaded by stress. For example, the coating composition can include a polysulfide manganese cured composition.

The corrosion inhibiting composition can also be an encapsulated corrosion inhibiting composition. The encapsulated corrosion inhibiting composition can comprise at least one film encapsulating the at least one organic heterocyclic compound of Formula 1 as described herein, at least one metal salt or mixed metal salt, in which the metal is selected from rare earth, alkali earth and transition metals, as described herein, or any aspects thereof, and a sealant comprising a non-stoichiometric composition and an activator. For example, the encapsulated corrosion inhibitor compositions can comprise at least one film; at least one metal salt or mixed metal salt, in which the metal is selected from the group consisting of Zn, La, Pr, Ce, Nd, Sm, Eu, Gd, Tb, Dy, Ho, Er, Tm, Yb, Lu, Co, Y, Ca, Sr, Ba, Sc, Zr, and combinations thereof; at least one organic heterocyclic compound of Formula 1 as described herein or any aspects thereof. The film can include a predetermined thickness and permeability to permit controlled diffusion of the particle ions upon interaction with water.

The corrosion inhibiting composition can be a corrosion inhibiting kit. The corrosion inhibiting kit can comprise two or more components and for example include instructions that the compounds are mixed prior to application onto a metal substrate. For example a first component can be at least one organic heterocyclic compound of Formula 1 as described herein and at least one metal salt or mixed metal salt, in which the metal is selected from rare earth, alkali earth and transition metals, as described herein, or any aspects thereof; and a second component can be a coating composition, for example a sealant composition and/or a paint composition. The sealant composition can include a polysulfide composition comprising a polysulfide base formulation and manganese, where the manganese can be mixed at a weight ratio of about 100:1 to about 100:20, by weight of the mixture to manganese, e.g., about 100:1 to about 100:5, about 100:5 to about 100:10, about 100:10 to about 100:15, about 100:15 to about 100:20, or about 100:5 to about 100:15. The paint composition can be an epoxy based paint composition. A third component can be an additive, for example a hardener for the resin or any additive described herein.

The compositions can include a list of ingredients, and/or components, and can also include a list of instructions for preparing and mixing together the ingredients, and/or components to make a coating composition.

It will be appreciated that the compositions can include one or more additives, such as pigments, fillers and extenders. Examples of suitable additives with which the corrosion inhibitors described herein can be combined include, for example, binders, solvents, pigments (including soluble or non-soluble extenders, fillers, corrosion-inhibiting pigments, and the like), solvents, additives (e.g., curing agents, surfactants, dyes, amino acids and the like), and so forth. Note that some additives can also properly be considered a pigment and vice versa (e.g., matting agents). More specifically, these “additives” include glycine, arginine, methionine, and derivatives of amino acids, such as methionine sulfoxide, methyl sulfoxide, and iodides/iodates, gelatin and gelatin derivatives, such as animal and fish gelatins, linear and cyclic dextrins, including alpha and beta cyclodextrin, triflic acid, triflates, acetates, talc, kaolin, organic-based ionic exchange resins, such as organic-based cationic and anionic exchange resins, organic-based ionic exchange resins, such as organic-based cationic and anionic exchange resins, organic-based ionic exchange resins that have been pre-exchanged or reacted with the salts, oxides, and/or mixed oxides of rare earth material, and metal sulfates, such as sulfates of rare earth materials, magnesium sulfate, calcium sulfate (anhydrous and hydrated forms), strontium sulfate, barium sulfate, and the like, and combinations thereof.

It will be appreciated that the compositions can comprise, or consist of any one or more of the components or additives described herein.

The compositions can also include other additives such as rheology modifiers, fillers, tougheners, thermal or UV stabilizers, fire retardants, lubricants, surface active agents. The additive(s) are usually present in an amount of less than about 10% based on the total weight of the activation treatment or the combination of solvent(s), agent(s) and additive(s). Examples include: rheology modifiers such as hydroxypropyl methyl cellulose (e.g. Methocell 311, Dow), modified urea (e.g. Byk 411, 410) and polyhydroxycarboxylic acid amides (e.g. Byk 405); film formers such as esters of dicarboxylic acid (e.g. Lusolvan FBH, BASF) and glycol ethers (e.g. Dowanol, Dow); wetting agents such as non-fluorochemical surfactants, (e.g., Multiwet™ VE, Croda) fluorochemical surfactants (e.g. 3M Fluorad) and polyether modified poly-dimethyl-siloxane (e.g. Byk 307, 333); surfactants such as fatty acid derivatives (e.g. Bermadol SPS 2543, Akzo) and quaternary ammonium salts; dispersants such as non-ionic surfactants based on primary alcohols (e.g. Merpol 4481, Dupont) and alkylphenol-formaldehyde-bisulfide condensates (e.g. Clariants 1494); anti foaming agents; anti corrosion reagents such as phosphate esters (e.g. ADD APT, Anticor C6), alkylammonium salt of (2-benzothiazolythio) succinic acid (e.g. Irgacor 153 CIBA) and triazine dithiols; stabilizers such as benzimidazole derivatives (e.g. Bayer, Preventol BCM, biocidal film protection); leveling agents such as fluorocarbon-modified polymers (e.g. EFKA 3777); pigments or dyes such as fluorescents (Royale Pigment and chemicals); organic and inorganic dyes such as fluoroscein; and Lewis acids such as lithium chloride, zinc chloride, strontium chloride, calcium chloride and aluminium chloride.

In at least one aspect, suitable flame retardants which retard flame propagation, heat release and/or smoke generation which can be added singularly or optionally include: phosphorus derivatives such as molecules containing phosphate, polyphosphate, phosphites, phosphazine and phosphine functional groups, for example, melamine phosphate, dimelamine phosphate, melamine polyphosphate, ammonia phosphate, ammonia polyphosphate, pentaerythritol phosphate, melamine phosphite and triphenyl phosphine; nitrogen containing derivatives such as melamine, melamine cyanurate, melamine phthalate, melamine phthalimide, melam, melem, melon, melam cyanurate, melem cyanurate, melon cyanurate, hexamethylene tetraamine, imidazole, adenine, guanine, cytosine and thymine; molecules containing borate functional groups such as ammonia borate and zinc borate; molecules containing two or more alcohol groups such as pentaerythritol, polyethylene alcohol, polyglycols and carbohydrates, for example, glucose, sucrose and starch; molecules which endothermically release non-combustible decomposition gases, such as, metal hydroxides, for example, magnesium hydroxide and aluminum hydroxide; and expandable graphite.

### Method of Selecting Corrosion Inhibitor Composition

The present disclosure also relates to a method for selecting a MOF in a corrosion inhibitor composition for inhibiting corrosion. For example, the methods can establish a selection of at least one organic heterocyclic compound of Formula 1 as described herein; at least one metal salt or mixed metal salt, in which the metal is selected from rare earth, alkali earth and transition metals, as described herein, or any aspects thereof; and at least one sealant, using a high throughput screening technique.

The rapid screening method for selecting a MOF in a corrosion inhibitor composition provides the following advantages: (1) it is rapid, for example it reduces the time per experiment and increases the number of experiments per unit time, (2) it reduces the preparation time per experiment and also reduces the time taken for the analysis of results and (3) it correlates with existing corrosion standards or testing methods. From an environmental viewpoint, the amount of material and solutions used and requiring disposal is significantly reduced using the described rapid screening method.

The rapid screening of corrosion inhibitor compositions can take place in a sodium chloride (NaCl) solution and at room temperature for 24 hours in an eighty-eight well polydimethylsiloxane block (PDMS) brought into contact with the surface of a metal substrate. The metal substrate can be a copper-containing alloy, such as copper-containing aluminium alloy. The NaCl solutions can be prepared at concentrations from about 10⁻¹ to about 10⁻⁶ M.

The rapid screening test allows for corrosion analysis of the corrosion inhibitor compositions through imaging. Image processing can be important for this technique to capture all of the corrosion damage in one image for processing. The semi-quantitative image analysis technique simultaneously analyses the corrosion to match the corrosion seen visually. Two photographs of the sample under different lighting conditions are combined using layers and inverse images in Adobe PhotoShop® to convert the resulting corrosion to a brightness value and then sample mask and background mask images are created for analysis. The observed corrosion is converted to corrosion values over a 0-10 scale, by using the brightness value and subtracting a reference value corresponding to the background mask image, with repetitions over 4 plates and multiple repetitions per plate consistently within 10% of each other, in accordance with a modified ASTM G71-81 protocol.

### Examples

A mixture of 1 gram of a MOF inhibitor (praseodymium 1,2,4-triazole-3-thiol “Pr-TT”) was incorporated for every 100-gram of a polysulfide base formulation (polysulfide from Royal Adhesives and Sealants) to form a 1:100 weight ratio of MOF inhibitor to polysulfide base formulation. The mixture was mixed using a high-speed mixer for 2 to 5 minutes, then degassed to eliminate entrapped air. The mixture was mixed with a manganese at a 100:10 mix weight ratio by weight to cure the polysulfide base formulation mixed with the MOF inhibitor.

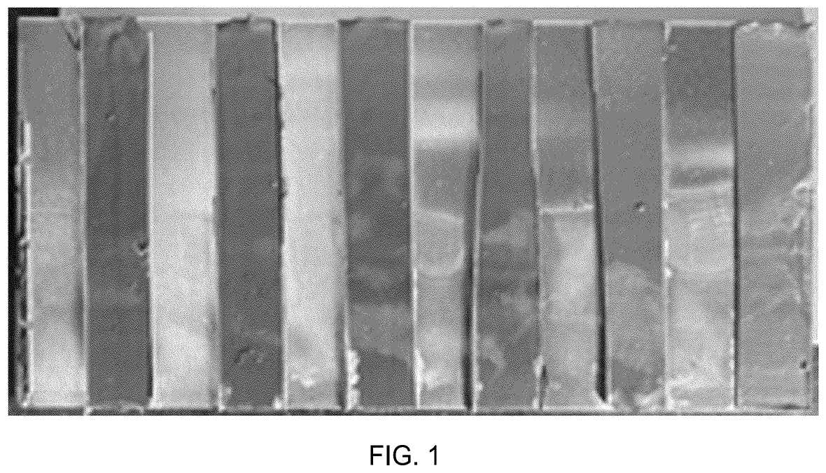

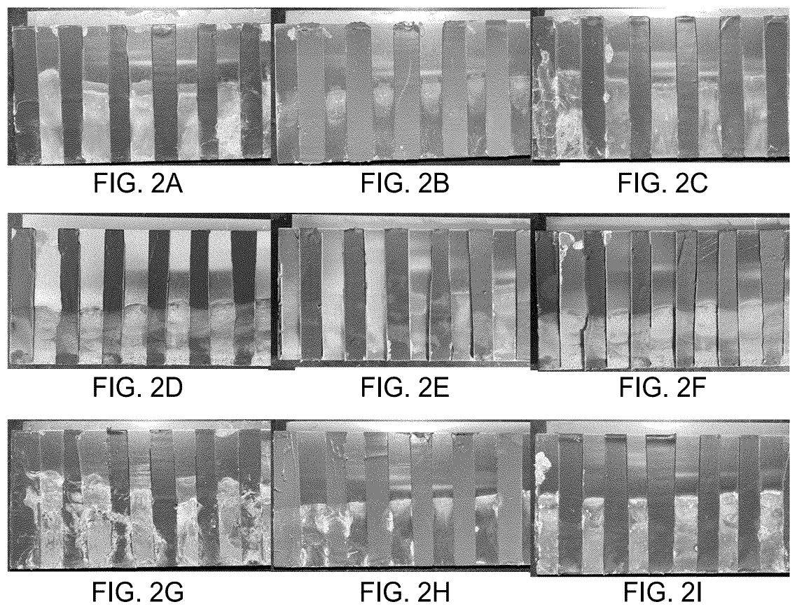

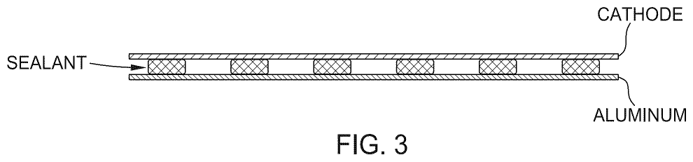

The mixture was applied on solvent-cleaned AMS-QQ-A-250/12 (bare aluminum) panels with nominal dimensions of 2.0 inches by 6 inches by 0.040 inch, as shown in FIG. 1. A commercially available chromated sealant from PPG, P/S 870 B-2, was used as a control. A negative control using Royal Adhesives and Sealants' commercially available uninhibited sealant, WS-8035 B-2, without the MOF inhibitor, was also used. Three specimens for each sealant were generated with strips of sealants on each panel with dimensions of 0.50-inch wide and 0.020-inch thick as shown in FIGS. 2A-2I. The sealants were allowed to cure for a nominal time of 336 hours prior test. Cadmium-plated stainless-steel panel, bare aluminum panel, and bare titanium panel were prepared as cathodes and placed over the specimens during the testing, as shown in FIG. 3.

Specimens were immersed in 3% sodium chloride solution for 14 days. Evaporated solution was regularly replenished with de-ionized water. The top portion of the panel was subjected to an alternative wet-dry and oxygen-rich condition while the bottom was permanently immersed in the saline solution, in accordance with a modified ASTM G71-81 protocol.

A coating composition having 1% wt% of the MOF inhibitor was utilized to determine the corrosion performance of the MOF inhibited sealant, as shown in FIGS. 2C, 2F, and 2I, was greater than the negative control, as shown in FIGS. 2A, 2D, and 2G. The 1% loading of the MOF inhibitor, as shown in FIGS. 2C, 2F, and 2I, showed similar corrosion performance to the chromated inhibited sealant, as shown in FIGS. 2B, 2E, and 2H. No stability issue occurred in the MOF inhibited sealant, e.g., agglomeration, after seven months.

### Further, the Disclosure Includes Examples According to the Following Clauses:

E1. A method of protecting a substrate from corrosion including applying a coating composition to a surface of the substrate, in which the coating composition includes: a corrosion inhibitor including a metal organic framework (MOF) including a metal ion coordinated to one or more organic ligands, in which the one or more organic ligands comprise at least one exocyclic sulphur group, and in which the metal ion of the MOFs comprises a rare earth metal or transition metal; and a sealant including a non-stoichiometric sensitive composition and an activator.
E2. The method of example E1, in which the corrosion inhibitor and the non-stoichiometric sensitive composition are mixed at a weight ratio of about 1:100 to about 100:15 of corrosion inhibitor to sealant.
E3. The method of any one of examples E1 or E2, in which the non-stoichiometric sensitive composition includes a polysulfide composition,
E4. The method of any one of examples E1-E3, in which the polysulfide composition includes a polysulfide manganese composition.
E5. The method of any one of examples E1-E4, further including mixing the corrosion inhibitor and the polysulfide composition to form a mixture.
E6. The method of any one of examples E1-E5, further including adding the activator to the mixture to cure the mixture, in which the activator includes manganese.
E7. The method of any one of examples E1-E6, in which manganese is added to the mixture at a weight ratio of about 100:5 to about 100:20 by weight of mixture to manganese.
E8. The method of any one of examples E1-E7, in which the one or more organic ligands including at least one exocyclic sulphur group are represented by Formula 1:

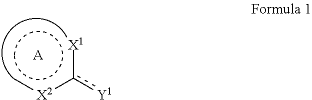

in which, A is a 5- or 6-membered aryl, heteroaryl or heterocyclic ring, which is optionally substituted with one or more substituents and optionally fused with one or more aryl or heteroaryl rings, in which a dotted line represents one or more optional double bonds;
Y¹ is selected from S or SH, in which a dotted line represents a double bond when Y¹ is S or is absent when Y¹ is SH;
X¹ is selected from N, NH, O, and S;
X² is selected from N, NR⁵, O, S, CR⁶ and CR⁷R⁸;
R⁵ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and
R⁶, R⁷ and R⁸, are each independently selected from hydrogen, halo, thiol, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted.
E9. The method of any one of examples E1-E8, the one or more organic ligands including at least one exocyclic sulphur group are selected from the group consisting of: 2-mercaptobenzimidazole (MBI), 3a,4-dihydrothiazolo[4,5-c]pyridine-2-thiol, benzo[d]thiazole-2(3H)-thione, 1,2,4-triazole-3-thiol, 2-amino,5-mercapto-1,2,4-thiadiazole, 5-methyl-2-mercapto-1,3,4-thiadazole, 4-amino-5-phenyl-3-mercapto-1,2,4-triazole, 5-mercapto-1-tetrazole-1H-acetic acid, sodium salt, 4,6-diamino-2-mercaptopyrimidine, 4-amino-2-mercaptopyrimidine, 2,6-diamino-4-mercaptopyrimidine, 9H-purine-8-thiol, 1H-imidazo[4,5-b]pyrazine-2-thiol, S-triazolo-[4,3-a]-pyridine-3-thione, 2-mercaptobenzimidazole, 1,2,4-triazole-3-thiol, 3-amino-5-mercapto-1,2,4,-triazole, 2-mercaptopyrimidine, 2-mercaptonicotinate, sodium salt, 4-mercaptobenzoate, sodium salt, 6-mercaptonicotinate, sodium salt, 1,3,5-triazine-2,4,6-trithiol, 1,3,5-triazine-2,4,6-trithiol, trisodium salt, and combinations thereof.
E10. The method of any one of examples E1-E9, in which the metal ion is selected from the group consisting of Zn, Pr, Mg, Al, and Ce.
E11. The method of any one of examples E1-E10, in which the metal ion is Pr.
E12. A method of protecting a substrate from corrosion including applying a coating composition to a surface of the substrate, in which the coating composition includes:
   a corrosion inhibitor comprising a metal organic framework (MOF) comprising a metal ion each coordinated to one or more organic ligands,
      in which the one or more organic ligands comprise at least one exocyclic sulphur group represented by Formula 1:

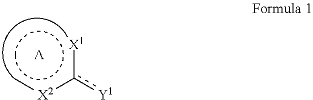

in which, A is a 5- or 6-membered aryl, heteroaryl or heterocyclic ring, which is optionally substituted with one or more substituents and optionally fused with one or more aryl or heteroaryl rings, in which a dotted line represents one or more optional double bonds;
Y¹ is selected from S or SH, in which a dotted line represents a double bond when Y¹ is S or is absent when Y¹ is SH;
X¹ is selected from N, NH, O, and S;
X² is selected from N, NR⁵, O, S, CR⁶ and CR⁷R⁸;
R⁵ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and
R⁶, R⁷ and R⁸, are each independently selected from hydrogen, halo, thiol, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted, and
in which the metal ion of the MOFs comprises a rare earth metal or transition metal; and
a sealant including a non-stoichiometric sensitive composition and an activator.
E13. The method of example E12, in which the substrate includes a metal substrate including an alloy of aluminum.
E14. The method of any one of examples E12 or E13, in which the corrosion inhibitor and the non-stoichiometric sensitive composition are mixed at a weight ratio of about 1:100 to about 100:15 of corrosion inhibitor to non-stoichiometric sensitive composition.
E15. The method of any one of examples E12-E14, in which the non-stoichiometric sensitive composition includes a polysulfide composition.
E16. The method of any one of examples E12-E15, further including mixing the corrosion inhibitor and the polysulfide composition to form a mixture.
E17. The method of any one of examples E12-E16, further including adding the activator to the mixture to cure the mixture, in which the activator includes manganese.
E18. The method of any one of examples E12-E17, in which manganese is added to the mixture at a weight ratio of about 100:5 to about 100:20 by weight of mixture to manganese.
E19. The method of any one of examples E12-E18, the one or more organic ligands including at least one exocyclic sulphur group are selected from the group consisting of: 2-mercaptobenzimidazole (MBI), 3a,4-dihydrothiazolo[4,5-c]pyridine-2-thiol, benzo[d]thiazole-2(3H)-thione, 1,2,4-triazole-3-thiol, 2-amino,5-mercapto-1,2,4-thiadiazole, 5-methyl-2-mercapto-1,3,4-thiadazole, 4-amino-5-phenyl-3-mercapto-1,2,4-triazole, 5-mercapto-1-tetrazole-1H-acetic acid, sodium salt, 4,6-diamino-2-mercaptopyrimidine, 4-amino-2-mercaptopyrimidine, 2,6-diamino-4-mercaptopyrimidine, 9H-purine-8-thiol, 1H-imidazo[4,5-b]pyrazine-2-thiol, S-triazolo-[4,3-a]-pyridine-3-thione, 2-mercaptobenzimidazole, 1,2,4-triazole-3-thiol, 3-amino-5-mercapto-1,2,4,-triazole, 2-mercaptopyrimidine, 2-mercaptonicotinate, sodium salt, 4-mercaptobenzoate, sodium salt, 6-mercaptonicotinate, sodium salt, 1,3,5-triazine-2,4,6-trithiol, 1,3,5-triazine-2,4,6-trithiol, trisodium salt, and combinations thereof.
E20. The method of any one of examples E12-E98, in which the metal ion is selected from the group consisting of Zn, Pr, Mg, Al, and Cc.
E21. The method of any one of examples E12-E20, in which the metal ions is Pr.

Overall, the coating compositions can include polysulfide compositions that provide a stable platform for the one or more organometallic compounds, e.g., metal-organic frameworks (MOFs), in a non-stoichiometrically sensitive system. The polysulfide composition can reduce production costs of producing a coating composition as compared to conventional sealant compositions that can incorporate strict stoichiometric ratios of reactants in the sealant, e.g., polythioethers or polyurethanes. The coating compositions can reduce and/or eliminate the use of chromates, increasing safety by reducing or limiting exposure of personnel to chromates. Additionally, the coating compositions can include one or more MOFs that include both metal and organic ligand corrosion inhibitors, where the combination of the metal and organic ligand corrosion inhibitors can synergistically reduce and/or prevent corrosion of the metal substrate

In the current disclosure, reference is made to various aspects. However, it should be understood that the present disclosure is not limited to specific described aspects. Instead, any combination of the features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects can achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As used herein “curable” or “cured” is descriptive of a material or composition that has or can be cured (e.g., polymerized or crosslinked) by heating to induce polymerization and/or crosslinking; irradiating with actinic irradiation to induce polymerization and/or crosslinking; and/or by mixing one or more components to induce polymerization and/or crosslinking. “Mixing can be performed, for example, by combining two or more parts and mixing to form a homogeneous composition. Alternatively, two or more parts can be provided as separate layers that intermix (e.g., spontaneously or upon application of shear stress) at the interface to initiate polymerization.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

The use of headings is for purposes of convenience only and does not limit the scope of the present disclosure. Aspects described herein can be combined with other aspects.

While the foregoing is directed to aspects of the present disclosure, other and further aspects of the disclosure can be devised without departing from the basic scope thereof, and the scope thereof is determined by the claims that follow. Furthermore, while the foregoing is directed to substrates, such as aircraft substrates, such as panels, coated lap joints between two or more panels, and wing-to-fuselage assemblies, aspects of the present disclosure can be directed to other substrates not associated with an aircraft, such as a multicomponent substrates used in aerospace, automotive, marine, energy industry, and the like.

What is claimed is:

1. A method of protecting a substrate from corrosion comprising applying a coating composition to a surface of the substrate, wherein the coating composition comprises:
a corrosion inhibitor comprising a metal organic framework (MOF) comprising a metal ion coordinated to one or more organic ligands,
wherein the one or more organic ligands comprise at least one exocyclic sulphur group, and
wherein the metal ion of the MOF comprises a rare earth metal or transition metal; and
a sealant comprising a non-stoichiometric sensitive composition and an activator.

2. The method of claim 1, wherein the corrosion inhibitor and the non-stoichiometric sensitive composition are mixed at a weight ratio of about 1:100 to about 100:15 of corrosion inhibitor to sealant.

3. The method of claim 2, wherein the non-stoichiometric sensitive composition comprises a polysulfide composition.

4. The method of claim 3, wherein the polysulfide composition comprises a polysulfide manganese composition.

5. The method of claim 3, further comprising mixing the corrosion inhibitor and the polysulfide composition to form a mixture.

6. The method of claim 5, further comprising adding the activator to the mixture to cure the mixture, wherein the activator comprises manganese.

7. The method of claim 6, wherein manganese is added to the mixture at a weight ratio of about 100:5 to about 100:20 by weight of mixture to manganese.

8. The method of claim 1, wherein the one or more organic ligands comprising at least one exocyclic sulphur group are represented by Formula 1: 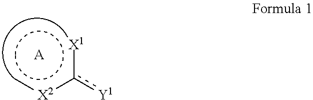
wherein, A is a 5- or 6-membered aryl, heteroaryl or heterocyclic ring, which is optionally substituted with one or more substituents and optionally fused with one or more aryl or heteroaryl rings, wherein a dotted line represents one or more optional double bonds;
Y¹ is selected from S or SH, wherein a dotted line represents a double bond when Y¹ is S or is absent when Y¹ is SH;
X¹ is selected from N, NH, O, and S;
X² is selected from N, NR⁵, O, S, CR⁶ and CR⁷R⁸;
R⁵ is selected from hydrogen, amino, C₁-C₁₀ alkyl, C₂-C₁₀ alkenyl, C₂-C₁₀ alkynyl, C₂-C¹⁰ aryl, and C₂-C₁₀ heteroaryl, in which each amino, alkyl, alkenyl, alkynyl, aryl or heteroaryl group can be optionally substituted; and
R⁶, R⁷ and R⁸, are each independently selected from hydrogen, halo, thiol, amino, C₁-C¹⁰ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted.

9. The method of claim 8, wherein the one or more organic ligands comprising at least one exocyclic sulphur group are selected from the group consisting of: 2-mercaptobenzimidazole (MBI), 3a,4-dihydrothiazolo[4,5-c]pyridine-2-thiol, benzo[d]thiazole-2(3H)-thione, 1,2,4-triazole-3-thiol, 2-amino,5-mercapto-1,2,4-thiadiazole, 5-methyl-2-mercapto-1,3,4-thiadazole, 4-amino-5-phenyl-3-mercapto-1,2,4-triazole, 5-mercapto-1-tetrazole-1H-acetic acid, sodium salt, 4,6-diamino-2-mercaptopyrimidine, 4-amino-2-mercaptopyrimidine, 2,6-diamino-4-mercaptopyrimidine, 9H-purine-8-thiol, 1H-imidazo [4,5-b] pyrazine-2-thiol, S-triazolo-[4,3-a]-pyridine-3-thione, 2-mercaptobenzimidazole, 1,2,4-triazole-3-thiol, 3-amino-5-mercapto-1,2,4,-triazole, 2-mercaptopyrimidine, 2-mercaptonicotinate, sodium salt, 4-mercaptobenzoate, sodium salt, 6-mercaptonicotinate, sodium salt, 1,3,5-triazine-2,4,6-trithiol, 1,3,5-triazine-2,4,6-trithiol, trisodium salt, and combinations thereof.

10. The method of claim 1, wherein the metal ion is selected from the group consisting of Zn, Pr, Mg, Al, and Ce.

11. The method of claim 10, wherein the metal ion is Pr.

12. A method of protecting a substrate from corrosion comprising applying a coating composition to a surface of the substrate, wherein the coating composition comprises:
a corrosion inhibitor comprising a metal organic framework (MOF) comprising a metal ion each coordinated to one or more organic ligands,
wherein the one or more organic ligands comprise at least one exocyclic sulphur group represented by Formula 1: 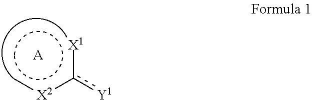
wherein, A is a 5- or 6-membered aryl, heteroaryl or heterocyclic ring, which is optionally substituted with one or more substituents and optionally fused with one or more aryl or heteroaryl rings, wherein a dotted line represents one or more optional double bonds;
Y¹ is selected from S or SH, wherein a dotted line represents a double bond when Y¹ is S or is absent when Y¹ is SH;
X¹ is selected from N, NH, O, and S;
X² is selected from N, NR⁵, O, S, CR⁶ and CR⁷R⁸;
R⁵ is selected from hydrogen, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted; and
R⁶, R⁷ and R⁸, are each independently selected from hydrogen, halo, thiol, amino, C₁-C₁₀ alkyl, C₂-C₁₀ alkenyl, C₂-C₁₀ alkynyl, C₂-C₁₀ aryl, and C₂-C₁₀ heteroaryl, in which each amino, alkyl, alkenyl, alkynyl, aryl or heteroaryl group can be optionally substituted, and
wherein the metal ion of the MOF comprises a rare earth metal or transition metal; and
a sealant comprising a non-stoichiometric sensitive composition and an activator.

13. The method of claim 12, wherein the substrate comprises a metal substrate comprising an alloy of aluminum.

14. The method of claim 12, wherein the corrosion inhibitor and the non-stoichiometric sensitive composition are mixed at a weight ratio of about 1:100 to about 100:15 of corrosion inhibitor to non-stoichiometric sensitive composition.

15. The method of claim 12, wherein the non-stoichiometric sensitive composition comprises a polysulfide composition.

16. The method of claim 15, further comprising mixing the corrosion inhibitor and the polysulfide composition to form a mixture.

17. The method of claim 16, further comprising adding the activator to the mixture to cure the mixture, wherein the activator comprises manganese.

18. The method of claim 17, wherein manganese is added to the mixture at a weight ratio of about 100:5 to about 100:20 by weight of mixture to manganese.

19. The method of claim 12, wherein the one or more organic ligands comprising at least one exocyclic sulphur group are selected from the group consisting of: 2-mercaptobenzimidazole (MBI), 3a,4-dihydrothiazolo[4,5-c]pyridine-2-thiol, benzo[d]thiazole-2 (3H)-thione, 1,2,4-triazole-3-thiol, 2-amino,5-mercapto-1,2,4-thiadiazole, 5-methyl-2-mercapto-1,3,4-thiadazole, 4-amino-5-phenyl-3-mercapto-1,2,4-triazole, 5-mercapto-1-tetrazole-1H-acetic acid, sodium salt, 4,6-diamino-2-mercaptopyrimidine, 4-amino-2-mercaptopyrimidine, 2,6-diamino-4-mercaptopyrimidine, 9H-purine-8-thiol, 1H-imidazo[4,5-b]pyrazine-2-thiol, S-triazolo-[4,3-a]-pyridine-3-thione, 2-mercaptobenzimidazole, 1,2,4-triazole-3-thiol, 3-amino-5-mercapto-1,2,4, -triazole, 2-mercaptopyrimidine, 2-mercaptonicotinate, sodium salt, 4-mercaptobenzoate, sodium salt, 6-mercaptonicotinate, sodium salt, 1,3,5-triazine-2,4,6-trithiol, 1,3,5-triazine-2,4,6-trithiol, trisodium salt, and combinations thereof.

20. The method of claim 12, wherein the metal ion is selected from the group consisting of Zn, Pr, Mg, Al, and Ce.

21. The method of claim 20, wherein the metal ion is Pr.
